(19) United States
(12) Patent Application Publication
(10) Pub. No.: US 2021/0403044 A1
(43) Pub. Date: Dec. 30, 2021

(54) SITUATION-ADAPTED ACTUATION FOR DRIVER ASSISTANCE SYSTEMS AND SYSTEMS FOR THE AT LEAST PARTIALLY AUTOMATED CONTROL OF VEHICLES

(71) Applicant: Robert Bosch GmbH, Stuttgart (DE)

(72) Inventors: Jochen Wieland, Renningen (DE); Ralf Kohlhaas, Calw (DE); Stefan Ruppin, Grafenau (DE); Steffen Waeldele, Renningen (DE)

(21) Appl. No.: 17/304,431

(22) Filed: Jun. 21, 2021

(30) Foreign Application Priority Data
Jun. 25, 2020 (DE) 10 2020 207 897.1

(51) Int. Cl. B60W 60/00; B60W 40/09; G06N 3/08; G06K 9/00; G06K 9/62; H04W 4/46

(52) U.S. Cl. CPC B60W 60/0017; B60W 40/09; H04W 4/46; G06K 9/00818; G06K 9/6256; G06N 3/08

(57) ABSTRACT

A method for generating an actuation signal for a driver assistance system and/or a system for the at least partially automated control of a vehicle. In the method, suggestions are made available for trajectories to be traveled by the vehicle and/or for other actions to be triggered that affect the driving dynamics of the vehicle. The suggestions are evaluated by a cost function, this cost function including a weighted sum of multiple cost terms, the weights being dynamically adapted. Utilizing the evaluations ascertained using the cost function, at least one trajectory or action is selected from among the suggestions. At least one actuation signal is generated that when conveyed to the driver assistance system or the system for the at least partially automatic control of the vehicle, induces the respective system to travel the selected trajectory with the vehicle or to trigger the suggested action.

### CROSS REFERENCE

The present application claims the benefit under 35 U.S.C. § 119 of German Patent Application No. DE 102020207897.1 filed on Jun. 25, 2020, which is expressly incorporated herein by reference in its entirety.

### FIELD

The present invention relates to decision-making in driver assistance systems and to systems for the at least partially automated control of vehicles.

### BACKGROUND INFORMATION

Driver assistance systems such as an electronic stability program continuously monitor the instantaneous driving situation with the aid of sensors and make decisions as to whether an intervention in the driving dynamics of the vehicle should be undertaken, e.g., by decelerating individual wheels. Systems for the at least partially automated control of a vehicle constantly intervene in the driving dynamics and plan multiple trajectories for a time period of a few seconds for this purpose. Based on the marginal conditions and optimization criteria, one of these trajectories will then be selected and traveled.

Mixed traffic involving human road users, in particular such human road users and other moving objects, may make it necessary to change plans on short notice. German Patent Application No. DE 10 2018 210 280 A1 describes a method for adapting the trajectory of a vehicle to the behavior of moving foreign objects.

### SUMMARY

Within the framework of the present invention, a method for generating an actuation signal for a driver assistance system and/or a system for the at least partially automated control of a vehicle are provided.

In accordance with an example embodiment of the present invention, the method provides suggestions for trajectories to be traveled by the vehicle, and/or for other actions to be triggered that affect the driving dynamics of the vehicle. The trajectory in particular may indicate the planned vehicle position in space and time, for instance. Other actions to be triggered may include the acceleration, deceleration or steering of individual wheels or of all wheels, for instance, or also the change between a normal drive and all-wheel drive, for example.

The suggestions are evaluated by a cost function. This cost function includes a weighted sum of multiple cost terms. Each one of these cost terms represents a requirement and/or an optimization goal for the behavior of the vehicle. For instance, the cost terms could be a measure of
the compliance with a predefined driving line, and/or
an avoidance of collisions with stationary and/or dynamic objects, and/or
the compliance with predefined marginal conditions with regard to the dynamics of the vehicle, and/or
the compliance with a minimum distance from a road boundary.

The cost terms, for example, may be modeled based on a physical model. There may be additional marginal conditions which, for instance, require that a collision freedom be an absolute must and may also not be replaced by other cost terms, no matter how advantageous.

Utilizing the evaluations ascertained using the cost function, at least one trajectory or action is selected from among the suggestions. At least one actuation signal is generated that, when conveyed to the driver assistance system or to the system for the at least partially automated control of the vehicle, induces the respective system to travel the selected trajectory with the vehicle or to trigger the suggested action.

In accordance with an example embodiment of the present invention, the weights of the cost terms between one another in the weighted sum are dynamically adapted to the current driving situation of the vehicle. The information about the current driving situation may come from various sources as is described in greater detail below.

It was recognized that the increasing number of cost terms in the cost function does basically make it possible to consider a multitude of preferences with regard to the driving behavior, but it may also lead to compromises that satisfy many goals to a certain degree without being really satisfactory for the actual situation. This tendency is counteracted in that the cost terms that are relevant for the current situation are preselected by the weighting. This also make it possible, for instance, to accelerate the reaction speed to a sudden change in the situation. The pressure to optimize the cost terms that are important in this situation directly affects the selection of a suggestion and is not partially buffered by other cost terms.

In an emergency situation, for example, the uppermost goal may consist of avoiding a looming collision with a suddenly appearing object. A child, for instance, may all of a sudden enter the road from between parked cars and be detectable only at that very moment. Also, a vehicle driving ahead may lose a poorly secured load. In this case, the braking distance may be too long to stop the own vehicle in a timely manner. However, the collision may possibly be avoided by an additional evasive maneuver. The cost terms that are important during normal driving and, for instance, require staying inside a predefined traffic lane or maintaining directional stability between road markings of the own traffic lane would penalize such an evasive maneuver. However, when the avoidance of a collision is the sole objective, then a move to a traffic space that happens to be unoccupied just then, e.g., the oncoming lane, constitutes the best solution. The normally useful cost terms should not distract from this optimal solution of all things.

The effect is even more pronounced in traffic situations that cannot entirely be managed without damage but only by accepting the lesser evil. For example, a sudden, strong deceleration that is indicated in order to avoid a collision with a pedestrian may entail the risk of a rear collision by trailing traffic. Furthermore, in a failure of the service brake when traveling downhill a mountain pass, it may be indicated to scrape along mountain walls or similar demarcations so that the vehicle sacrifices itself as a “metal brake” and at least saves the health of the passengers.

The weights of the cost terms may particularly depend on
the current driving speed of the own vehicle, and/or
speeds of other moving objects in the vehicle environment and their distance from the own vehicle, and/or
the type and number of other moving or stationary objects in the vehicle environment, and/or
the category and topography of the currently traveled road (e.g., superhighway, country road, inner-city road, uphill grade, downhill grade); and/or
the condition of the road (such as a road in poor condition, or potholes), and/or
weather conditions.

In one particularly advantageous embodiment, the current driving situation is evaluated utilizing measuring data from at least one sensor installed in the vehicle and/or utilizing information obtained via a vehicle-to-vehicle (V2V) communication, and/or utilizing information obtained via a vehicle-to-infrastructure (V2I) communication.

For example, with the aid of sensors of the vehicle, it can be ascertained that a worsening of the coefficient of friction of a tire-road contact of the vehicle due to snow or ice, for instance, has occurred or is imminent. Any sudden steering, accelerating or braking in such a situation may cause the static friction of the tires to transition to sliding friction and the vehicle to be no longer controllable. Accordingly, cost terms that demand the avoidance of such sudden maneuvers may be weighted considerably higher.

However, the same information, for instance, may also be obtained via a vehicle-to-vehicle (V2V) communication from other vehicles that have already encountered the slippery road conditions. A warning of slippery road conditions is also able to be disseminated to vehicles via a unidirectional or bidirectional vehicle-to-infrastructure (V2I) communication, e.g., via traffic radio or via cell broadcast messages in a mobile radio network.

In a further particularly advantageous embodiment of the present invention, the measuring data and/or at least one variable derived therefrom are mapped by a trained artificial neural network, ANN, to at least one characteristic variable that characterizes the current driving situation, and/or to the weights of the cost terms relative to one another. For instance, from experiences obtained from test drives, it can therefore be learned in a direct manner which weighting of cost terms is useful in the respective situation. Because of the generalization capability of the ANN, suitable weighting is then also able to be ascertained in situations not encountered up to this point.

The evaluation of the current driving situation, for instance, may particularly include an evaluation of a coefficient of friction for a tire-road contact of the vehicle and/or the semantic meaning of traffic signs in the environment of the vehicle. This includes variable traffic signs which, for example, are shown as a light displays on overhead sign structures. For instance, the slippery road warning may also be obtained from such a variable sign. In general, traffic signs are an important source of information about the current driving situation because they are particularly able to display changes with regard to a situation stored in digital map material, for instance.

In one further advantageous embodiment of the present invention, measured values of at least one measuring variable or values of a variable derived therefrom that were recorded at different points in time or were evaluated from measured values recorded at different points in time, are used for ascertaining a model of a Gaussian process which is in line with these measured values or values. A Gaussian process generally represents functions whose function values are able to be given only as normal distributions with specific uncertainties and probabilities. Accordingly, expected values, variances and covariances, for instance, are sufficient to characterize the Gaussian process.

Using this model, a value of the measuring variable or the derived variable for a point in time for which no measured values are available is then ascertained. This value is therefore interpolated from the available measured values.

In another advantageous embodiment of the present invention, the correction of an estimation of the current driving situation and/or the correction of the weights of the cost terms is/are learned with the aid of reinforcement learning. In reinforcement learning, a strategy is independently learned with the goal of maximizing rewards obtained in an interaction with a process, that is to say, of collecting as many positive rewards and as few negative rewards as possible.

In the process, an intervention in the driving dynamics of the vehicle suggested and/or carried out by a driving dynamics and/or driver assistance system independently of the suggestions to be examined is evaluated as a negative reward within the framework of such reinforcement learning. In particular an electronic stability program, for example, is able to be used for this purpose. Such a system intervenes in the driving dynamics in particular when the vehicle unexpectedly finds itself in a physical limit range and is on the verge of breaking away. In a meaningful driving strategy, however, it must be expected that the vehicle will be reliably kept out of the limit range simply by evaluating handling suggestions using the cost function. The fact that the suggestion, which was selected based on the cost function and should actually already include the full information for the actuation of the vehicle, still has to be “straightened out” by an intervention of a further system is an indication that this suggestion was not quite appropriate to the situation after all and that the wrong priorities were possibly set when arriving at the solution.

In one further advantageous embodiment of the present invention, the selection of a trajectory or an action from among the suggestions includes a check as to whether a current fill state of at least one energy store of the vehicle and/or a current degradation state of the vehicle permit(s) travel along the suggested trajectory or the triggering of the suggested action.

In the case of a hybrid vehicle, for example, the electric motor may supply an additional acceleration reserve that makes it possible to still drive away from a looming collision with a trailing vehicle. However, this acceleration reserve is available only if the traction battery supplying the electric motor has an adequate charge state. If the charge state is too low, then the trajectory that uses the acceleration reserve is effectively not utilizable.

In the same way, the maintenance state of bumpers, for instance, may decide whether an evasive maneuver featuring a tight curve radius is possible without risk or whether a breakaway of the vehicle is imminent. If the maintenance state is poor, then the suggestion for the evasive maneuver may be discarded.

The functionality of the present method may be embodied in a control unit, for instance. For example, such a control unit in particular is capable of supplying signals that are able to be conveyed directly to actuators of the vehicle such as via a CAN bus or some other bus system. Therefore, the present invention also relates to a control unit for carrying out the previously described method.

The control unit includes an environment model module, which is set up to process measuring-technological observations of the vehicle environment and, optionally, to process map data into a model of the vehicle environment.

In addition, a behavior planning module is provided. This behavior planning module is designed at least to ascertain from the model of the vehicle environment trajectories that are collision-free for a predefined period of time as the suggested trajectories. The behavior planning module is also designed to dynamically adapt weights of cost terms in a weighted sum included in a cost function to the current driving situation of the vehicle. The behavior planning module evaluates the suggestions using this cost function so that the behavior planning module selects at least one trajectory based on these evaluations.

Moreover, a movement planning module is provided. This movement planning module is designed to translate the selected trajectory into actuations of individual actuators of the vehicle.

In a particularly advantageous embodiment of the present invention, this movement module is additionally designed to check to what extent a current fill state of at least one energy store of the vehicle and/or a current degradation state of the vehicle permit(s) travel of the selected trajectory.

The modules in the control unit may be realized in hardware, in software or in any mixed form. For instance, the control unit may be derived from an existing control unit in that the behavior planning module is expanded to the previously described behavior planning module by an exchange or by a software upgrade.

The above-described method(s) may be computer-implemented, in particular entirely or partially. The present invention therefore also pertains to a computer program having machine-readable instructions that when executed on a computer or on multiple computers, induce the computer(s) to carry out the previously described method. In this sense, control units for vehicles and embedded systems for technical devices that are likewise capable of executing machine-readable instructions should also be considered computers.

In the same way, the present invention also relates to a machine-readable data carrier and/or to a download product having the computer program. A download program is a digital product which is transmittable via a data network, that is to say, downloadable by a user of the data network, the digital product being offered for sale for an immediate download by an online vendor, for instance.

Additional measures that improve the present invention are described in greater detail below together with the description of the preferred exemplary embodiments of the present invention with the aid of the figures.

### BRIEF DESCRIPTION OF THE DRAWINGS

FIG. 1 shows an exemplary embodiment of method 100 for generating actuation signal 5, in accordance with the present invention.

FIG. 2 shows an exemplary embodiment of control unit 10, in accordance with the present invention.

### DETAILED DESCRIPTION OF EXAMPLE EMBODIMENTS

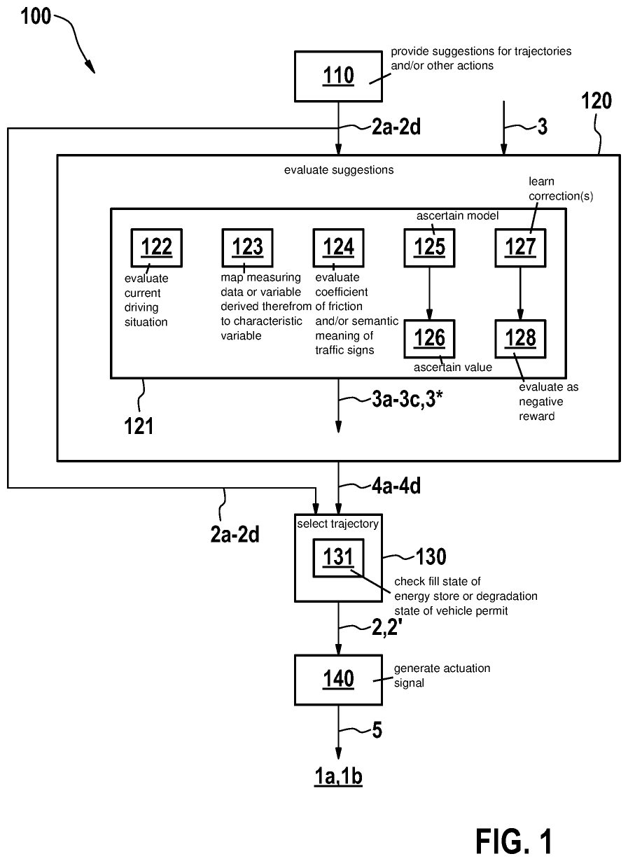

FIG. 1 is a schematic exemplary embodiment of method 100 for generating an actuation signal 5 for a driver assistance system 1a, and/or for a system 1b for the at least partially autonomous control of a vehicle, in accordance with the present invention.

In step 110, suggestions 2a-2d for trajectories 2 to be traveled by the vehicle are provided and/or suggestions for other actions 2′ to be triggered that influence the driving dynamics of the vehicle.

In step 120, suggestions 2a-2d are evaluated using a cost function 3. This cost function 3 includes a weighted sum 3* of multiple cost terms 3a-3c. Each cost term 3a-3c represents a requirement and/or an optimization goal for the behavior of the vehicle. According to block 121, the weights of cost terms 3a-3c in weighted sum 3* relative to one another are dynamically adapted to the current driving situation of the vehicle.

In step 130, utilizing evaluations 4a-4d ascertained using cost function 3, at least one trajectory 2 or action 2′ is selected from among suggestions 2a-2d. According to block 131, this may particularly include a check as to what extent a current fill state of at least one energy store of the vehicle and/or a current degradation state of the vehicle permit(s) travel of the suggested trajectory or triggering of the suggested action.

In step 140, at least one actuation signal 5 for driver assistance system 1a or for system 1b for the at least partially automated control of the vehicle is generated. This signal is developed in such a way that when conveyed to respective system 1a, 1b, it induces system, 1a, 1b to travel selected trajectory 2 with the vehicle or to trigger suggested action 2′.

Different possibilities for dynamically adapting the weights of cost terms 3a-3d to the current driving situation of the vehicle have been marked in box 121.

According to block 122, the current driving situation is able to be evaluated utilizing measuring data from at least one sensor installed in the vehicle and/or utilizing information included in a vehicle-to-vehicle (V2V) communication and/or utilizing information received via a vehicle-to-infrastructure (V2I) communication.

According to block 123, the measuring data and/or at least one variable derived therefrom is/are able to be mapped by a trained artificial neural network, ANN, to at least one characteristic variable that characterizes the current driving situation and/or to weights of the cost terms 3a-3c relative to one another.

According to block 124, a coefficient of friction for a tire-road contact of the vehicle and/or the semantic meaning of traffic signs in the environment of the vehicle is/are able to be evaluated.

According to block 125, from measured values of at least one measuring variable or values of a variable derived therefrom that were recorded at different points in time or were evaluated from measured values recorded at different points in time, a model of a Gaussian process that is in line with these measured values or values is able to be ascertained. According to block 126, a value of the measured variable or the derived variable is able to be ascertained with the aid of this model for a point in time for which no measured values are available.

According to block 127, a correction of an estimation of the current driving situation and/or the correction of the weights of the cost terms is/are able to be learned using reinforcement learning. An intervention in the driving dynamics of the vehicle suggested and/or carried out by a driving dynamics system and/or driver assistance system independently of suggestions 2a-2d to be checked is evaluated as a negative reward within the framework of this reinforcement learning. (Block 128). It is thus assumed that it was not the optimal mutual weighting of cost terms 3a-3c that was used when arriving at suggestion 2a-2d. If this weighting had been optimal, then suggestion 2a-2d, taken by itself, would already yield results for the actuation of the vehicle and would not additionally have to be “straightened out” by an intervention of another system.

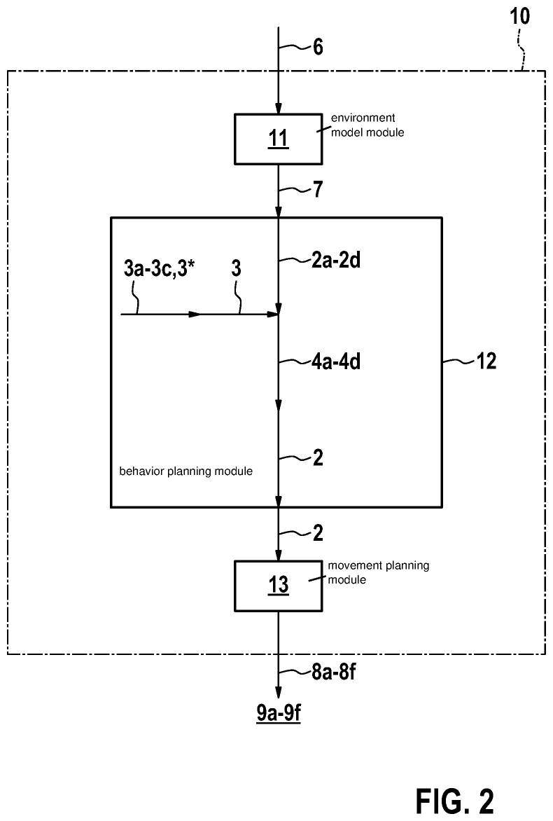

FIG. 2 shows an exemplary embodiment of a control unit 10. Control unit 10 includes an environment model module 11, which is designed to process measuring data 6 from monitoring the vehicle environment and optionally also to process map data into a model 7 of the vehicle environment. This model 7 is forwarded to behavior planning module 12 of control unit 10.

Based on model 7 of the vehicle environment, behavior planning module 12 is used to ascertain as suggested trajectories 2a-2d trajectories that are collision-free for a predefined period of time. The predefined time period may be on the order of magnitude of 5 to 7 seconds, for instance.

Moreover, in behavior planning module 12, weights of cost terms 3a-3c in a weighted sum 3* which is included in a cost function 3 are furthermore dynamically adapted to the current driving situation of the vehicle. Suggestions 2a-2d are evaluated with the aid of this cost function 3. At least one trajectory 2 is selected from suggestions 2a-2d on the basis of evaluations 4a-4d of suggestions 2a-2d.

Movement planning module 13 of control unit 10 translates this selected trajectory 2 into actuations 8a-8f of individual actuators 9a-9f of the vehicle.

1-12. (canceled)

13. A method for generating an actuation signal for a driver assistance system and/or for a system for the at least partially automated control of a vehicle, the method comprising the following steps:
making available suggestions for trajectories to be traveled by the vehicle, and/or for other actions to be triggered that affect driving dynamics of the vehicle;
evaluating the suggestions using a cost function, the cost function including a weighted sum of multiple cost terms, and each one of the cost terms representing a requirement and/or an optimization goal for behavior of the vehicle;
selecting, utilizing the evaluations ascertained using the cost function, at least one trajectory or action from among the suggestions; and
generating at least one actuation signal that when conveyed to the driver assistance system or to the system for the at least partially automatic control of the vehicle, induces the driver assistance system or to the system for the at least partially automatic control of the vehicle to travel the selected trajectory with the vehicle or to trigger the selected action;
wherein weights of the cost function are dynamically adapted, relative to one another in the weighted sum, to a current driving situation of the vehicle.

14. The method as recited in claim 13, wherein the current driving situation is evaluated utilizing measuring data of at least one sensor installed in the vehicle and/or utilizing information obtained via a vehicle-to-vehicle communication and/or utilizing information obtained via a vehicle-to-infrastructure communication.

15. The method as recited in claim 14, wherein the measuring data and/or at least one variable derived from the measuring data are mapped by a trained artificial neural network to at least one characteristic variable that characterizes the current driving situation, and/or to the weights of the cost terms relative to one another.

16. The method as recited in claim 14, wherein the evaluation of the current driving situation includes an evaluation of a coefficient of friction for tire-road contact of the vehicle and/or a semantic meaning of traffic signs in an environment of the vehicle.

17. The method as recited in claim 14, wherein:
from measured values of at least one measuring variable or values of a variable derived from the at least one measuring value that were recorded at different points in time or were evaluated from measured values recorded at different points in time, a model of a Gaussian process is ascertained that is in line with the measured values or values, and
using the model, a value of the measuring variable or the variable derived from the at least one measuring value is ascertained for a point in time for which no measured values are available.

18. The method as recited in claim 13, wherein a correction of an estimation of the current driving situation and/or a correction of the weights of the cost terms is learned using learning reinforcement, and an intervention in the driving dynamics of the vehicle suggested and/or carried out by a driving-dynamics system and/or a driver assistance system independently of the suggestions is evaluated as a negative reward within the framework of the learning reinforcement.

19. The method as recited in claim 13, wherein the selection of a trajectory or an action from among the suggestions includes a check to ascertain to what a degree a current fill state of at least one energy store of the vehicle and/or a current degradation state of the vehicle, permits travel of the vehicle of the suggested trajectory or the triggering of the suggested action.

20. The method as recited in claim 13, wherein the cost function includes at least one cost term, which is a measure of:
compliance with a predefined travel line, and/or
an avoidance of collisions with stationary and/or dynamic objects, and/or
compliance with predefined marginal conditions with regard to dynamics of the vehicle, and/or
compliance with a minimum distance from a road delimitation.

21. A control unit configured to generate an actuation signal for a driver assistance system and/or for a system for the at least partially automated control of a vehicle, the control unit comprising:
an environment model module configured to process observations of a vehicle environment into a model of the vehicle environment;
a behavior planning module configured to:
ascertain from the model of the vehicle environment trajectories that are collision-free for a predefined time period as suggested trajectories,
dynamically adapt weights of cost terms in a weighted sum included in a cost function to a current driving situation of the vehicle,
evaluate the suggestions using the cost function, and
select at least one trajectory based on the evaluation, and
a movement planning module configured to translate the selected trajectory into actuations of individual actuators of the vehicle.

22. The control unit as recited in claim 21, wherein the environment model module also processes map data into the model of the vehicle environment.

23. The control unit as recited in claim 21, wherein the movement planning module is configured to check to what extent a current fill state of at least one energy store of the vehicle and/or a current degradation state of the vehicle, permits travel of the selected trajectory.

24. A non-transitory machine-readable data carrier on which are stored machine-readable instructions for generating an actuation signal for a driver assistance system and/or for a system for the at least partially automated control of a vehicle, the machine-readable instruction, when executed by one or more computers, causing the one or more computers to perform the following steps:
making available suggestions for trajectories to be traveled by the vehicle, and/or for other actions to be triggered that affect driving dynamics of the vehicle;
evaluating the suggestions using a cost function, the cost function including a weighted sum of multiple cost terms, and each one of the cost terms representing a requirement and/or an optimization goal for behavior of the vehicle;
selecting, utilizing the evaluations ascertained using the cost function, at least one trajectory or action from among the suggestions; and
generating at least one actuation signal that when conveyed to the driver assistance system or to the system for the at least partially automatic control of the vehicle, induces the driver assistance system or to the system for the at least partially automatic control of the vehicle to travel the selected trajectory with the vehicle or to trigger the selected action;
wherein weights of the cost function are dynamically adapted, relative to one another in the weighted sum, to a current driving situation of the vehicle.
